(19) United States
(12) Patent Application Publication
(10) Pub. No.: US 2005/0121031 A1
(43) Pub. Date: Jun. 9, 2005

(54) Impact-protected advanced ruggedized augmented reality instrumented self contained breathing apparatus

(76) Inventor: John Franklin Ebersole JR., Bedford, NH (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/027,046

(22) Filed: Dec. 31, 2004

Related U.S. Application Data
(63) Continuation-in-part of application No. 10/739,575, filed on Dec. 17, 2003.
(63) Continuation-in-part of application No. 10/213,392, filed on Aug. 6, 2002.

(51) Int. Cl. A62B 18/00; A62B 17/04

(52) U.S. Cl. 128/201.27; 128/201.22

(57) ABSTRACT

An impact-protected ruggedized Self Contained Breathing Apparatus (SCBA) instrumented with electronic and passive equipment so that the instrumented SCBA can be used in augmented reality-based training. The instrumented SCBA includes a breathing portion adapted to cover at least the user's mouth and nose, and a plastic shell covering at least some of the electronic and passive equipment from shock and environmental hazards. Mechanical devices couple the shell and the breathing portion. There is at least one resilient external member connected to the outside of the shell, to assist in the impact resistance of the shell.

### CROSS REFERENCE TO RELATED APPLICATIONS

This application is a Continuation in Part of “Advanced Ruggedized Augmented Reality Instrumented Self Contained Breathing Apparatus”, Ser. No. 10/739,575, filed on Dec. 17, 2003, and of “A Ruggedized Instrumented Firefighter's Self Contained Breathing Apparatus”, Ser. No. 10/213,392, filed on Aug. 6, 2002. The disclosures of both parent applications are incorporated herein by reference.

### FIELD OF THE INVENTION

This invention relates to protection of equipment used for purposes of immersing a user in an augmented reality (AR) or virtual reality (VR) environment.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

Information establishing the real-time position and orientation of a user's head is useful for both Augmented Reality (AR) and Virtual Reality (VR). AR involves the ability to acquire images of the user's environment, augment those images with computer-generated elements, and display the composite images to the user, from the user's perspective. This information can be gathered by instrumenting a Self Contained Breathing Apparatus (SCBA). This instrumentation is sensitive, however, and will not function if it is subjected to severe shock or other undesirable environmental hazards, such as penetration by water. The undesirable presence of shock or pollutants can result in negative effects ranging from bad calibration of equipment all the way to equipment failure or equipment destruction. Therefore, it is very desirable to protect SCBA equipment being used for AR and VR.

### SUMMARY OF THE INVENTION

A Self Contained Breathing Apparatus (SCBA) is instrumented with a head-mounted display (HMD), camera, and tracking equipment, and has a protective shell enclosing all of this equipment. Different implementations of tracking equipment can make an improvement in tracking quality. The wearer's breathing comfort can be improved by allowing better airflow, and possibly even allowing the use of a firefighter's standard compressed air regulator. The instrumentation and protective shell adds a fair amount of weight, and adding a pad that rests on the user's head can help to support some of that weight, providing a better overall user experience. The shell can be protected from shock through the use of rubber bumpers. The inventive SCBA can be used by firefighters, emergency first responders, miners, industrial workers and others who use SCBA equipment and need to be trained while wearing such equipment.

### BRIEF DESCRIPTION OF THE DRAWINGS

FIG. 1 schematically depicts one embodiment of basic imaging and position determining components for the invention;

FIG. 2 is a side view of the inventive SCBA being worn by a user;

FIG. 3 depicts overlapping acoustic fields of view of acoustic microphones to achieve effective tracking in the embodiment of FIG. 2;

FIG. 4 depicts the layout of optical fields of view of optical sensors to achieve effective tracking in an alternative embodiment of the invention;

FIG. 5 schematically depicts the tracking space in which a user of the invention may be located, in relation to the tracking devices placed in the room;

FIG. 6 schematically depicts the operation of the tracking system for the invention in regard to tracking objects in the ceiling when the user is upright;

FIG. 7 is a view similar to that of FIG. 6, but with the user instead looking down at the floor, rather than straight ahead;

FIGS. 8A, 8B and 8C are front, rear, and lower front views of the preferred embodiment of the fully assembled shell for the invention;

FIGS. 9A and 9B are front and rear views, respectively, of this shell without the upper and lower resilient elastomeric partial covers;

FIGS. 10A and 10B are front and rear views, respectively, of the upper resilient elastomeric partial cover for this embodiment;

FIGS. 11A and 11B are front and rear views, respectively, of the lower resilient elastomeric partial cover for this embodiment of the invention;

FIG. 12 is a front perspective view of the SCBA of the preferred embodiment of the invention;

FIGS. 13A-C are right front, rear and left front perspective views, respectively, of the partially assembled apparatus of the preferred embodiment invention;

FIGS. 14A-C are right front, left front and rear perspective views, respectively, of the more fully assembled apparatus of the preferred embodiment invention;

FIGS. 15A-C are right front, left front and rear perspective views, respectively, of the still more fully assembled apparatus of the preferred embodiment invention; and

FIGS. 16A-D are side and perspective cross-sectional views of the right side, and are side and perspective cross-sectional views of the left side, respectively, of the preferred embodiment of the invention.

### DETAILED DESCRIPTION OF THE PREFERRED EMBODIMENTS OF THE INVENTION

Equipment to be Protected

In the preferred embodiment of the invention, the SCBA to be used is a Scott® Air-Pak® SCBA. The instrumentation for the SCBA consists of (1) a head mounted display (HMD) used to show an image to the user; (2) a camera used to acquire the image the user is looking at; (3) a system used to measure the SCBA orientation and the SCBA position; and (4) a prism used to shift the image in front of the user's eyes so that the image is in front of the camera. All of this equipment, except for the prism, has electrical connections that carry signals through a tether to a computer, which receives and processes these signals, then sends an augmented image and sound back to the user.

Layout of Components

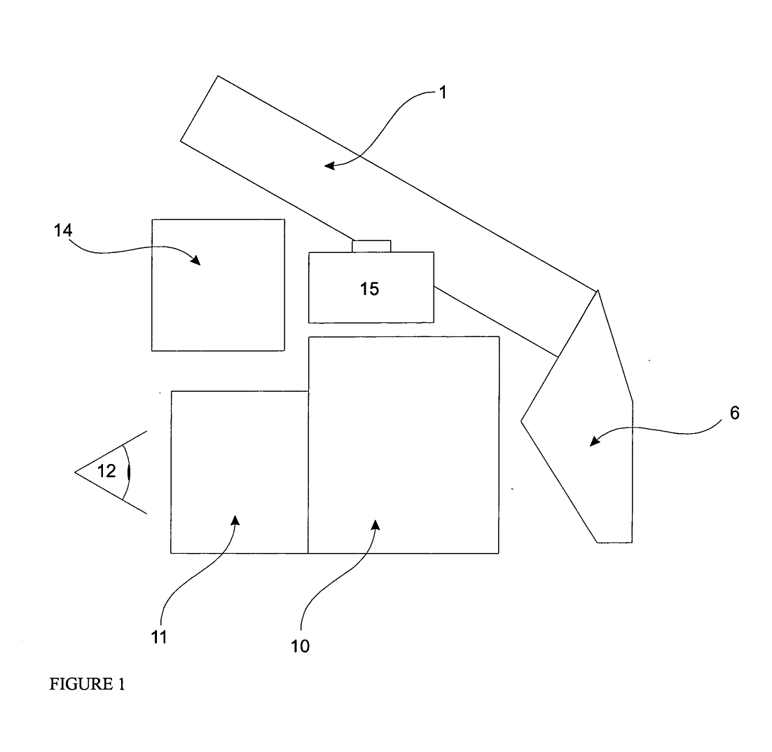

In FIG. 1, the eye 12 of the person wearing the SCBA (not shown) looks through the optics 11 to see the image formed on the display element inside the electronics portion 10 of the HMD. Separately, the image of the outside world is captured by camera 1, which looks through a prism 6 that has two reflective surfaces to bend the path of light to the camera 1. The position and orientation tracking system components, whether using an optical, acoustic, or other type of system, are shown here as 14 and 15, though the specific components may differ depending on the tracking system.

Equipment Mounting and Connections

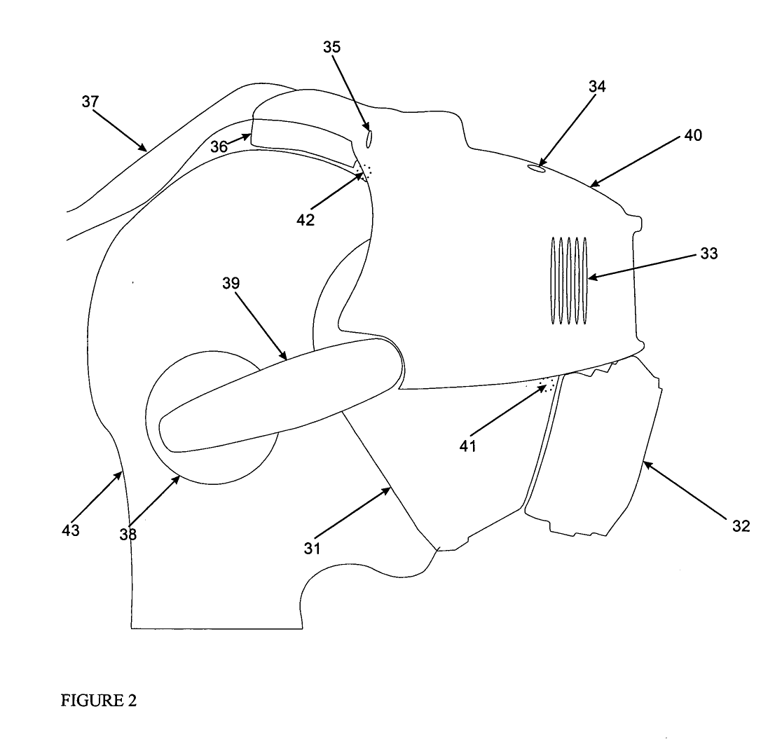

The HMD is mounted directly to the SCBA. SCBA position and orientation tracking system components are attached rigidly to the camera/prism assembly (or mirrors if those are used), or to the SCBA/shell assembly, locking their positions together. By locking the position tracking equipment directly or indirectly to the camera/prism assembly, one can ensure that the computer-generated imagery will correspond to the camera's position. A hard plastic electronics enclosure or shell 40 (FIGS. 2 and 8-11) attaches to the SCBA 31, preferably with bolts, providing a means for hiding from view and protecting from the elements all electronic equipment, except for the microphones 34 and 35, which must be exposed to the air to allow the separate speakers (not shown) to transmit ultrasonic chirps to the microphones. The plastic shell 40 that surrounds all of the equipment is made of a tough material, such as nylon, that can withstand the shock of being dropped, yet is slightly bendable, allowing for a little bit of inherent shock-mounting for the equipment. Preferably, in order to increase shock resistance, the HMD 10, prism 6, camera 1, and/or tracking equipment is mounted to the SCBA 31 and plastic shell 40 with rubber mounting points (not shown). In this case the HMD, prism, camera, and/or tracking equipment are all mounted together with a very rigid structure, for example a metallic frame (shown below). That rigid structure is then mounted separately to the plastic shell, preferably with shock-absorbing mounts.

Overview of FIG. 2

In FIG. 2, a side view (the user 43 wearing the unit would face to the right) of the fully assembled system can be seen from the outside. The SCBA (self-contained breathing apparatus) 31 from Scott® Air-Pak® is modified as described below to mount the augmented reality equipment to it. The SCBA regulator 32, is unmodified from Scott® Air-Pak®, and may be used either with or without compressed air depending on implementation in the system. Louvered vent holes 33 in the shell 40 may be used if necessary for proper airflow and cooling of internal components. Shell 40 may be made of several individual pieces, but as a whole serves to protect the internal components. Microphone pairs 34 and 35 (four total) are part of the tracking system that tell computer equipment where the user is looking, a critical ability of the augmented reality system. Head pad 36 rests on the user's head 43, and relieves much of the pressure that the user's face would otherwise be feeling. Cable bundle 37 exits the shell with a protective and flexible covering around the individual cables. Headphone 38 is mounted on headphone arm 39, which in turn is mounted to the SCBA 31.

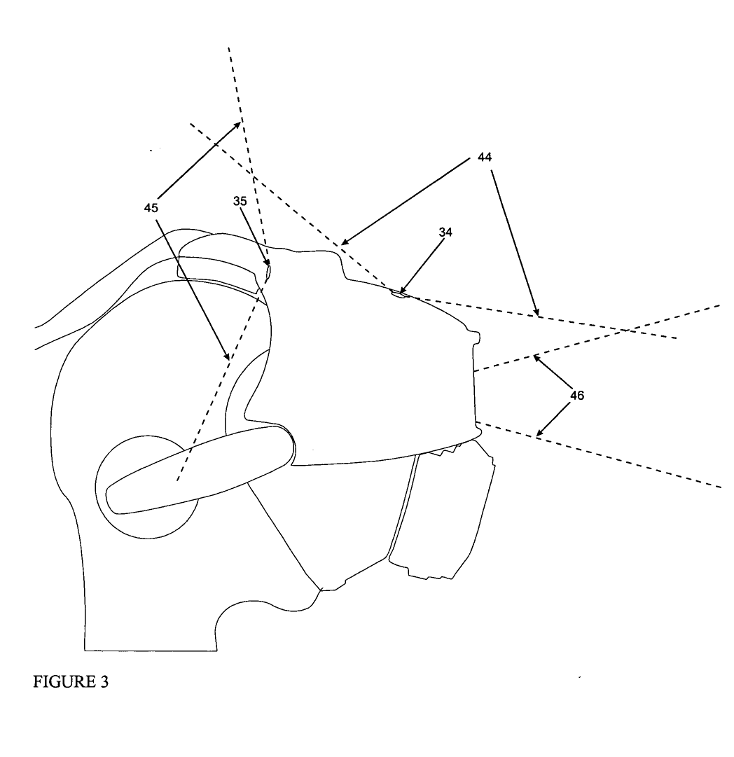

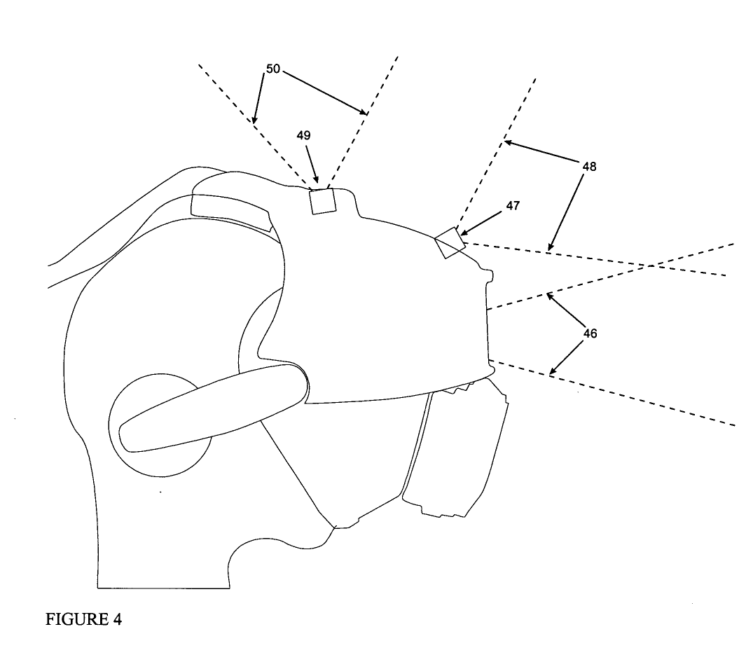

Overview of FIG. 3

Microphone pair 34 and pair 35 (such as that available in the InterSense IS-900 system available from InterSense, Burlington, Mass.) each have a conical acoustic field of view (FOV) 44 and 45, respectively, which allow each pair to “see” the acoustic transmitters elsewhere in the user's space in order to achieve tracking. The preferred embodiment is to have the FOVs overlap so that the system can always track the user's head position. As the user tilts his/her head forward, FOV 44 may not be able to “see” acoustic transmitters located, typically, in the ceiling above the user. At this point, the use of FOV 45 allows the overall system to still “see” the acoustic transmitters. An alternative embodiment is to substitute optical sensors for the acoustic microphones 34 and 35. The camera's field of view is indicted by cone 46.

Overview of FIG. 4

FIG. 4 shows an embodiment with optical position sensor 49 with FOV 50 and optical position sensor 47 with FOV 48. The FOV 48 is shown overlapping (in this instance) the user's/camera's FOV 46.

Improvements in Tracking Due to Multiple Microphone Placement

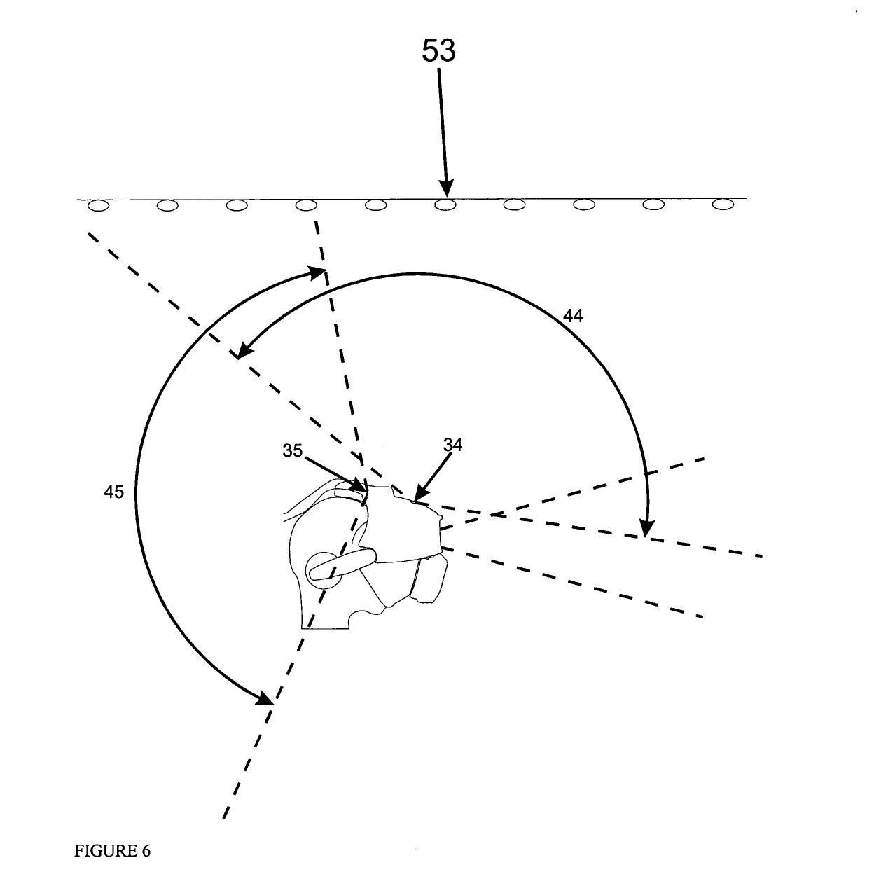

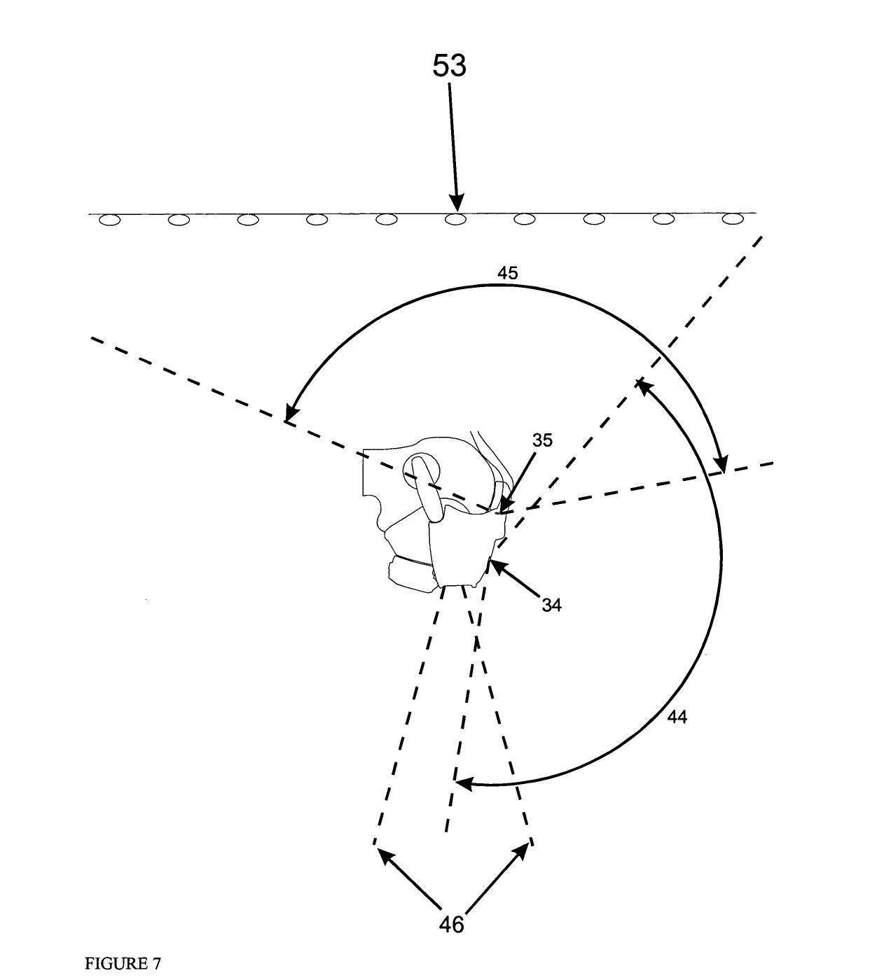

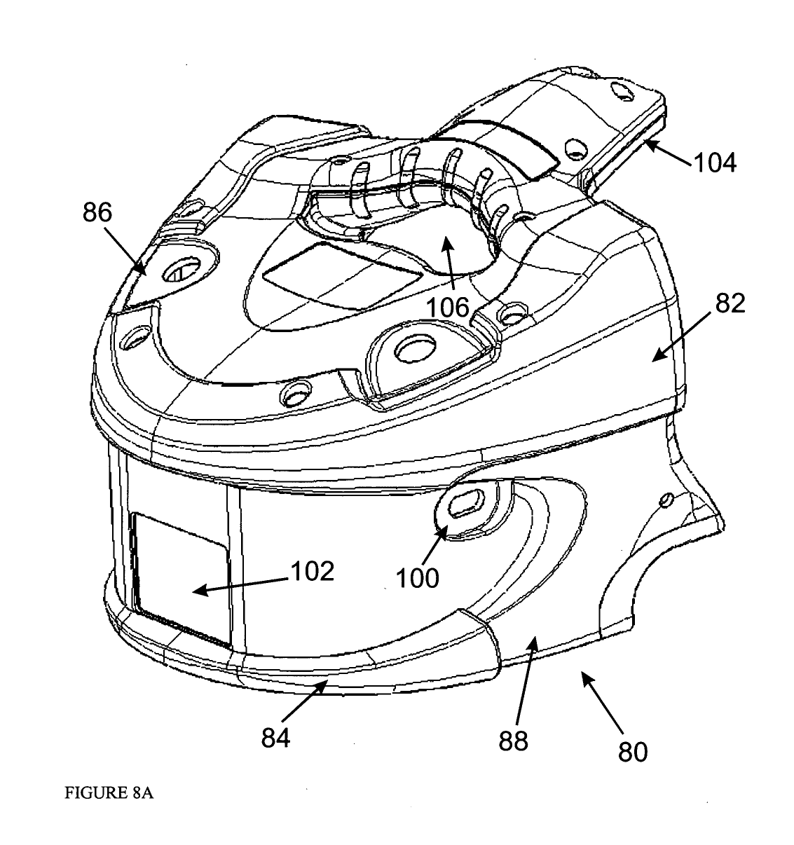

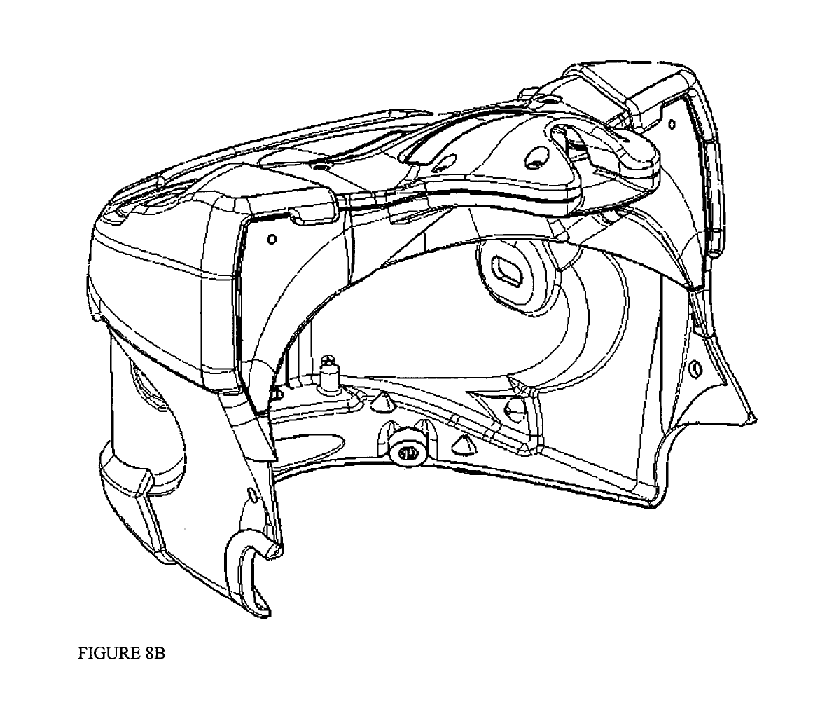

In parent application Ser. No. 10/213,392, only one pair of tracking speakers were used, and they were located between microphone pairs 34 and 35, pointing straight up towards the ceiling-mounted tracking system components, which were microphones. In certain circumstances, especially when the user was at the end of the tracking area and looking down at the floor as in FIG. 7, the single pair of speakers could no longer “see” the tracking components 53 in the ceiling, and the system would lose track of the user. To combat this, the preferred embodiment of the present invention uses two pairs of microphones 34 and 35 at two different locations, with one pair 34 on the top of the shell pointing up and forward, and one pair 35 on the back of the shell pointing back and up, as in FIGS. 3, 6 and 7. This configuration allows the user to go to the very end of the tracking area and look down and still be tracked. Note that the field of view (FOV) 44 for microphone pair 34 and FOV 45 for microphone pair 35 in a preferred embodiment overlap each other, to ensure improved tracking. Note that the microphones do not theoretically need to be in pairs, but at least two are needed for tracking, and three or more are needed for improved tracking when near the edge of the tracking range, and four or more are needed to track really well.

Improvements in Tracking Due to Shielding

Some of the tracking electronics suffer from interference from other equipment inside the unit, so shielding was added to surround the circuit board and power supplies, and then the shielding was grounded, which solved the problem.

Improvements in Tracking Due to Use of Optical Tracking Systems

In another embodiment, the microphones are replaced by optical sensors, such as those made by InterSense, to perform the tracking achieved by the ultrasonic microphones/receiver. The optical sensors detect, and process by an onboard or offboard computer, images of objects in the field of view of the sensor. In one embodiment, these objects may be prescribed optical patterns affixed in various locations in the space in which the user is located. In another embodiment, the objects may be indigenous to the location, i.e., optical processing is performed on images of objects already located in the space.

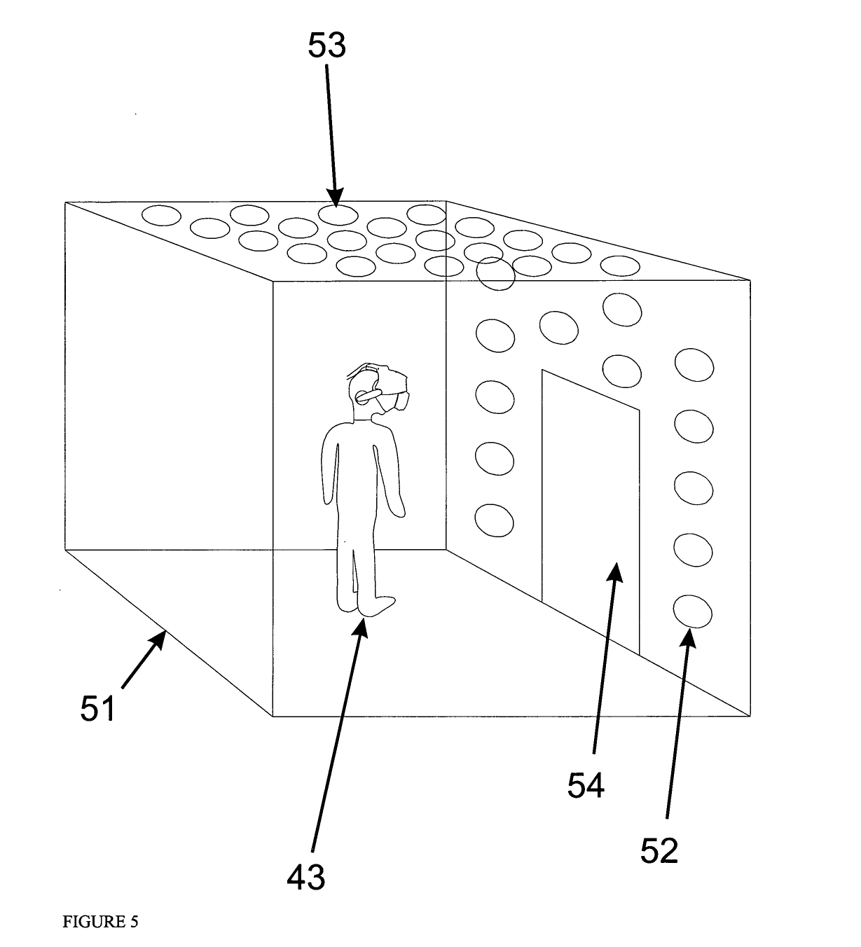

When an optical tracking system is used, the optical sensor (or sensors) should be placed on the unit to maximize visibility of optical targets in the space. In a situation where the space has a tall ceiling, a single sensor 49, FIG. 4, may be sufficient since its FOV 50 is able to see the ceiling (and any targets 53, FIG. 5, on the ceiling) when the user is looking straight and level. With a low ceiling, a more frontwards facing sensor 47 may be more appropriate since its FOV 48 can see optional targets 52, FIG. 5, on the walls. Additionally, since FOV 48 overlaps the majority of the user's FOV 46, the tracker will help to optimize the tracking of targets 52, FIG. 5, in the locations that the user is looking at, such as aiding accurate tracking next to a door 54, FIG. 5. In the preferred embodiment, both sensors 47 and 49 are implemented to maximize tracking FOV coverage, with the two FOVs 48 and 50 laid out so as to create neither a significant gap nor a significant overlap (this is shown in FIG. 4 as the left ray of FOV 48 running parallel to the right ray of FOV 50). Also in the preferred embodiment, there would be a known pattern of tracking targets 52 and 53 available to maximize accuracy of tracking.

Improvements in Breathing Comfort for the User Due to Use of a Passive Regulator

Typically, when users are wearing an SCBA with no regulator attached, a fair amount of their exhaled air goes up into the mask, causing a “fogging” problem and obscuring the view. A Scott® Air-Pak® EZ-Flow regulator 32, FIG. 2, with no compressed air attached, can be effectively used as a one-way valve. If the holes that lead up to the rest of mask at location 41 are plugged up, then exhaled air will go through only the regulator, and not back up into the rest of the mask. In this configuration, when the user breaths out, air exits through the regulator. When the user breathes in, fresh air is drawn in through gaps at location 42, between the shell 40 and SCBA 31. This air drawn in flows over the components inside the shell 40 that are prone to becoming “fogged up”, thus minimizing the problem. Added benefits to this include: (1) cooling the user since the fresh air blows across the user's face 43, (2) the original regulator can be used, thus retaining realistic equipment, (3) no compressed air is required, thus making use and maintenance of the equipment easier, and (4) if the SCBA produces a good seal to the user's face, then virtually all of the exhaled air will exit the mask directly.

Improvements in Breathing Comfort for the User Due to Use of Compressed Air with a Regulator

When an SCBA is used normally by a user (without augmented reality instrumentation), it is used with compressed air driving the regulator. Under that circumstance, the SCBA is under a very minor positive pressure, and any leaks in the seal of the mask to the user's face will result in air leaking out. In one embodiment of the invention, the air gaps are very large, and a large amount of air would leak by under normal circumstances. If the regulator is used with the “purge” setting, the amount of constantly leaking flow can be controlled with the “purge” knob, and only a small amount of airflow needs to be used to obtain a dramatically improved cooling effect for both the user and electronics. This implementation may be beneficial as it allows the use of compressed air, and can provide adequate cooling for the equipment and user. In this case, the holes that lead up to the rest of mask at location 41 should not be plugged up, since some of the dry, cool air should go up the mask to “defog” the electronics.

Alternatively, the invention can be made to be air tight, and compressed air can be used in the normal fashion. In this implementation, it would be wise to add a one-way valve in the shell 40 at location 42. This additional one-way valve would allow the user to still breath properly with this unit and retain equipment cooling, in the situation where the compressed air supply has run out or is not attached.

Improvements in Equipment Cooling Due to Use of Louvered Air Vents

Louvered side vents 33 may be used if specific equipment cooling is needed. Some equipment may need fans, blowing air either in or out of the shell 40. By making the holes louvered (in the preferred embodiment) instead of flat holes, (1) it will be more difficult for users to accidentally cover the holes with their hands, (2) foreign objects will be less likely to enter the unit, and (3) the appearance of the holes will be more appealing.

Improvements in User Comfort Due to Use of a Foam Head Pad

The foam head pad 36 rests on the head 43 of the wearer, just above the forehead, and is attached to the shell 40. Normally, the SCBA 31 is fully supported by the rubber gasket of the SCBA resting on the user's face. With the additional weight of the augmented reality instrumentation, it can become uncomfortable, and the head pad 36 relieves a great deal of the perceived weight.

Improvements in Durability Due to Use of Advanced Cable Shielding

The cable bundle 37 leaving would be just raw cable with standard shielding from the manufacturer. To improve utility and life span of the cable bundle as a whole, a slippery, yet very durable and flexible outside wrap around the bundle should be used. The preferred embodiment herein is to use Kevlar® or any other kind of material with improved performance.

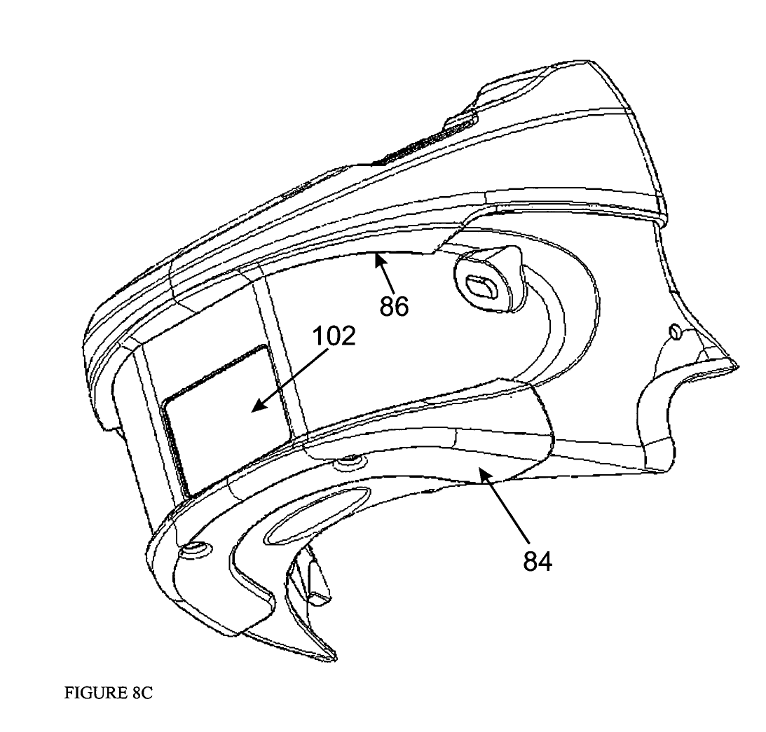

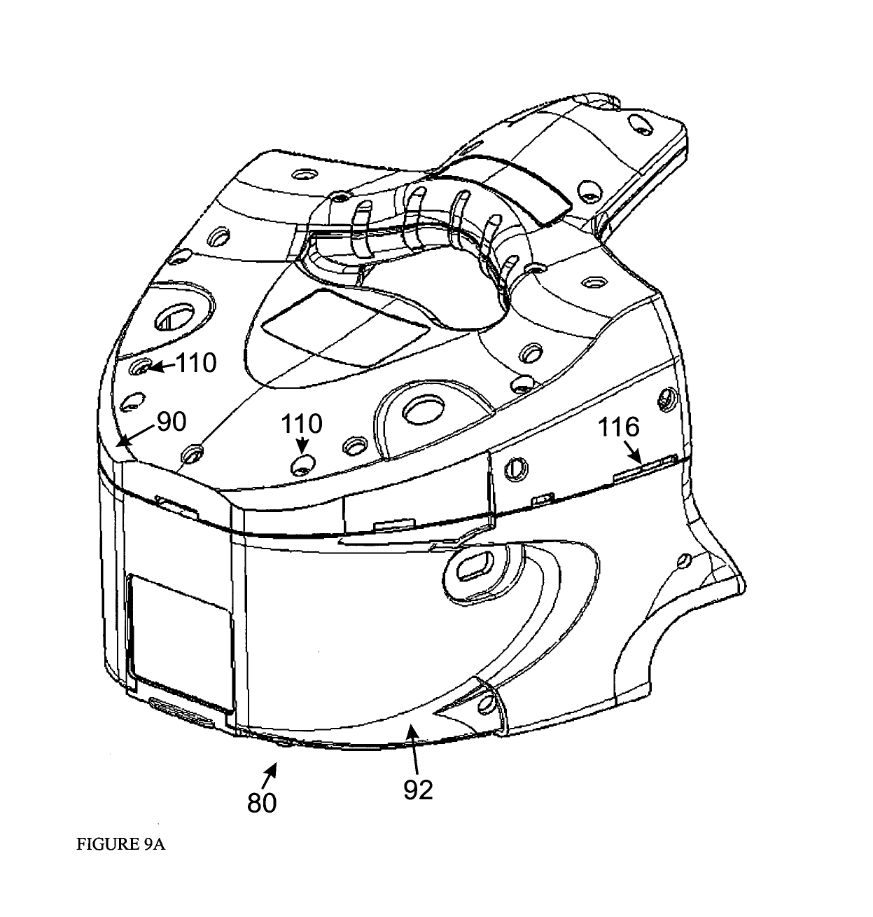

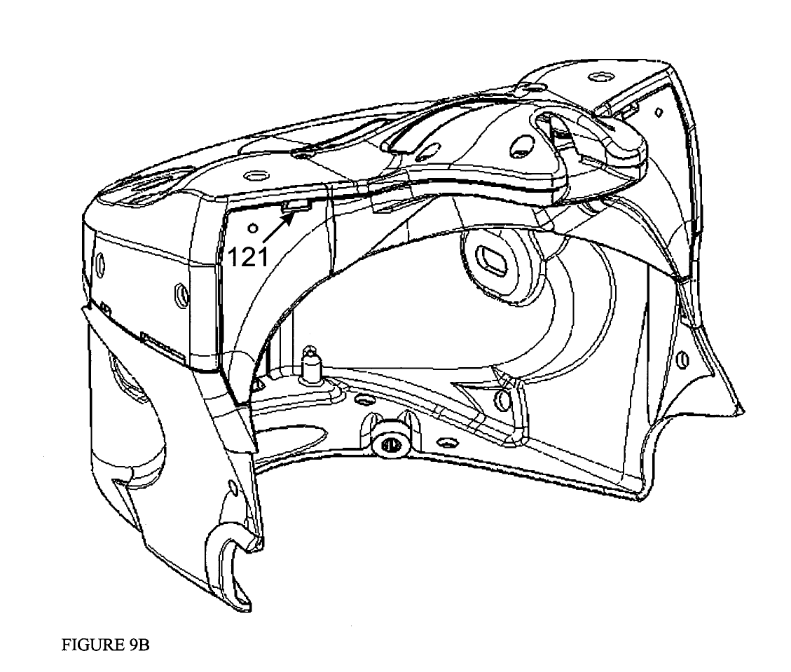

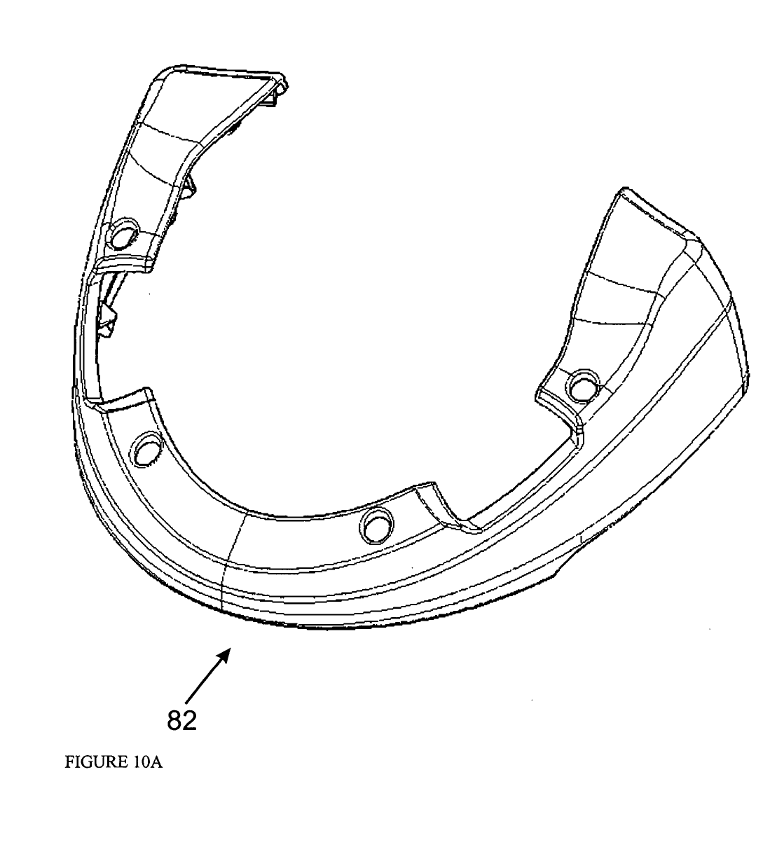

As mentioned above, the shell is preferably designed to resiliently mount the electronics, optics and tracking system hardware. The shell is preferably also partially protected from external impacts through the use of strategically placed cushioning bumpers. These features of the preferred embodiment of the invention are shown in FIGS. 8A-8C, 9A-9B, 10A-10B, and 11A-11B.

Preferred shell 80 is a molded nylon member made from four major portions. Upper shell section 86 and lower shell section 88 are each unitary molded members. These two shell sections fit together in an interference fit. The other two main components are upper resilient elastomeric partial cover 82 and lower resilient elastomeric partial cover 84. These two partial covers are preferably mechanically coupled to the shell and provide resilience to the shell at locations at which the shell is likely to contact another surface. This can happen, for example, when the shell is removed and placed on the floor, or while the shell is being carried or even worn by a user. In the embodiment, these partial covers cover upper external ridge 90 and lower external ridge 92 of shell 80. As is shown in the drawings, partial covers 82 and 84 when mounted to the shell provide a more rounded appearance to the brow and chin of the shell.

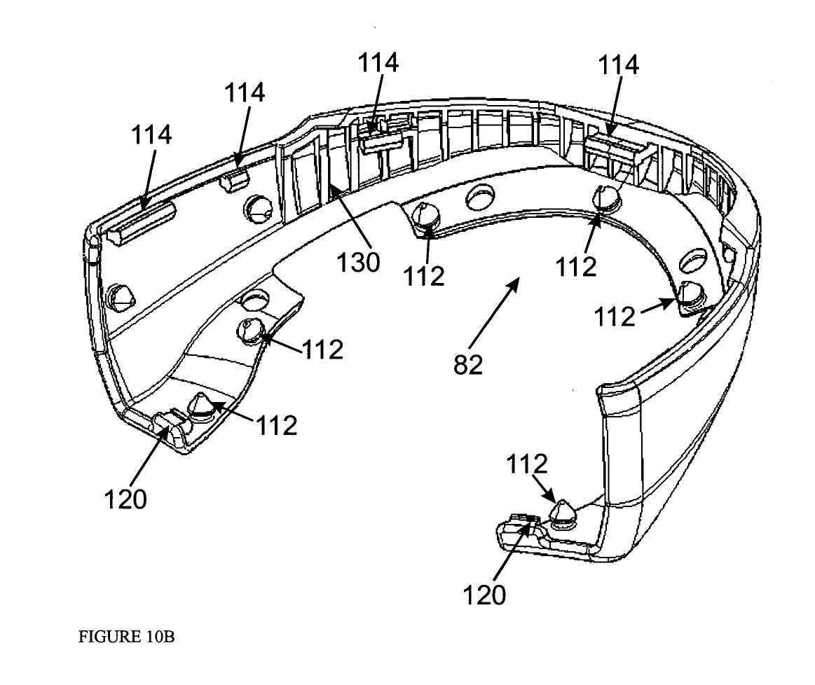

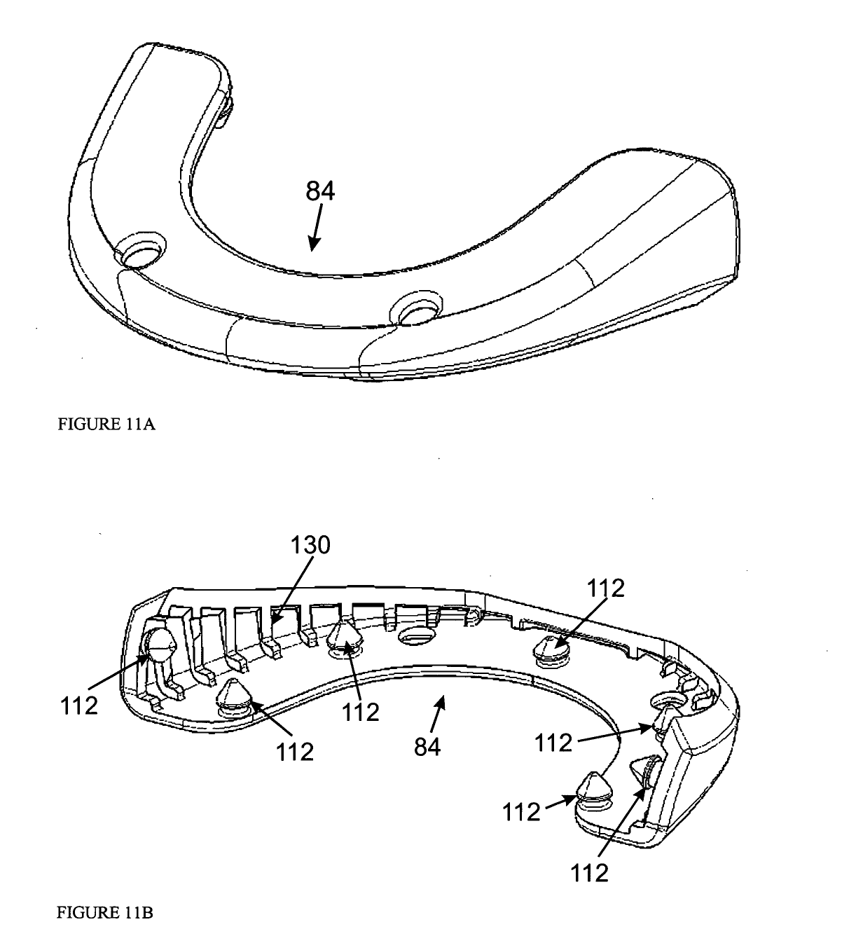

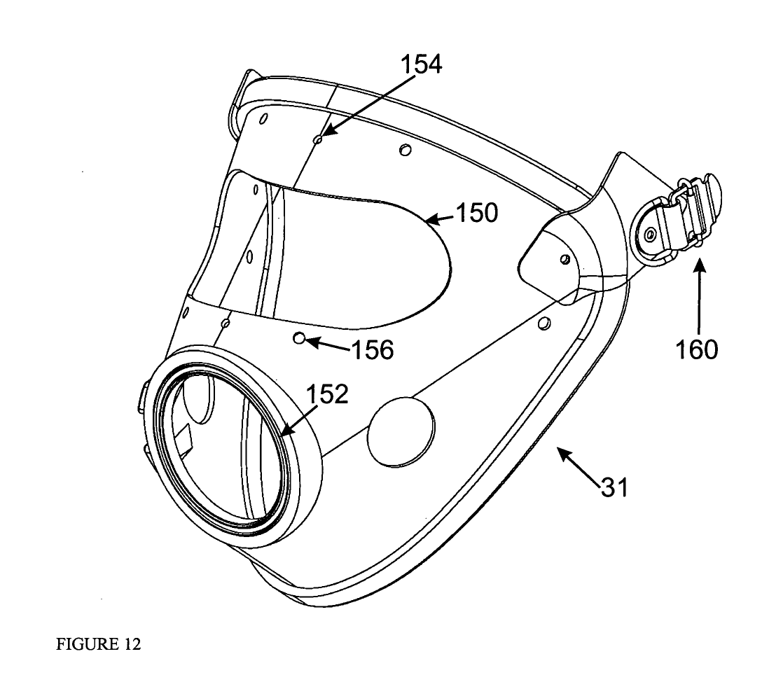

Partial covers 82 and 84, FIGS. 10 and 11, are coupled to the shell through mechanical coupling elements. Upper partial cover 82, FIGS. 10A and 10B, includes a number of inwardly-projecting, enlarged-head (mushroom shaped) coupling lugs 112 that are arranged to be inserted into matching mounting openings 110 in the shell. Lugs 112 have a tapered head and a narrowed neck, to allow them to be pushed through openings that are smaller in diameter than the largest diameter of the head of the lug. Because the lugs are made of elastomer such as rubber, they can deform and fit through the smaller holes. The enlarged head then inhibits the lug from being pulled out of the opening. Lower partial cover 84, FIGS. 11A and 11B, also includes a number of such coupling lugs 112.

Spaced vertical ribs 130 provide more of a cushion than would solid rubber.

Upper partial cover 82 is also coupled to the shell through inwardly-projecting coupling members 114 that fit into slots between shell sections 86 and 88. These members also have enlarged inner portions that extend to the inside of the shell and are larger than the slots in which they are held to inhibit their removal from the slots. Finally, upper partial cover 82 includes inwardly projecting tabs 120 that fit into shell openings 121, FIG. 9B.

The SCBA 31 is shown in FIG. 12. Face mask opening 150 and regulator opening 152 are shown. A series of three fastener holes 154 and a second series of three fastener holes 156 are used to couple the shell and the active components to SCBA 31, as shown in more detail below. Buckle 160 holds an adjustable strap that passes behind the user's head.

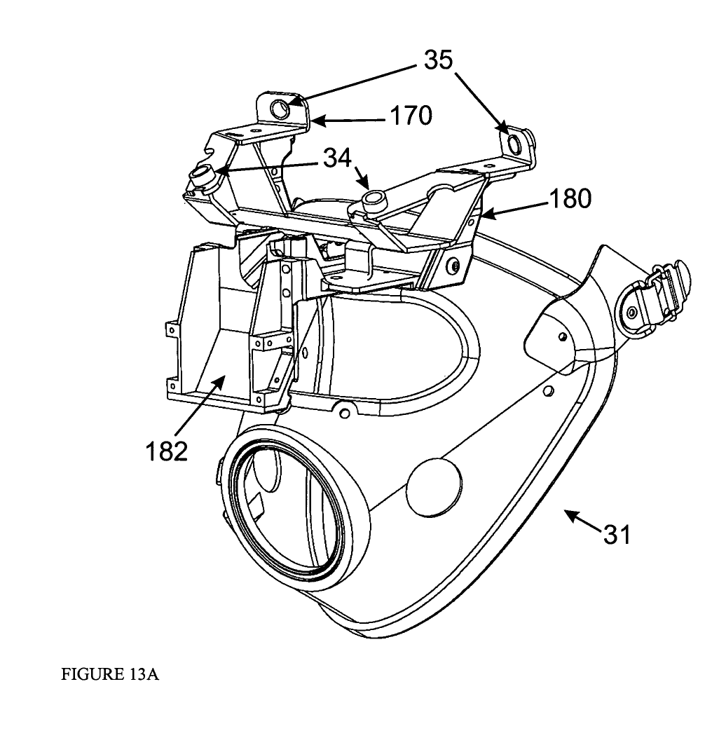

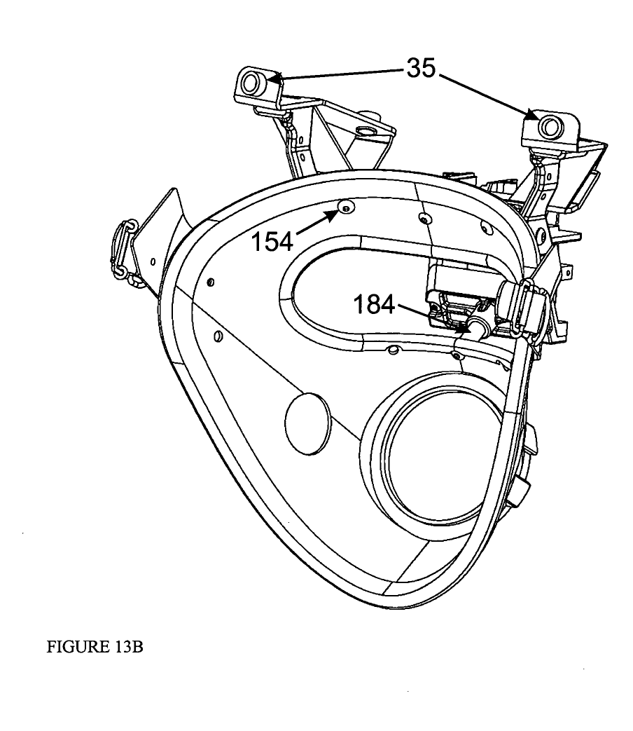

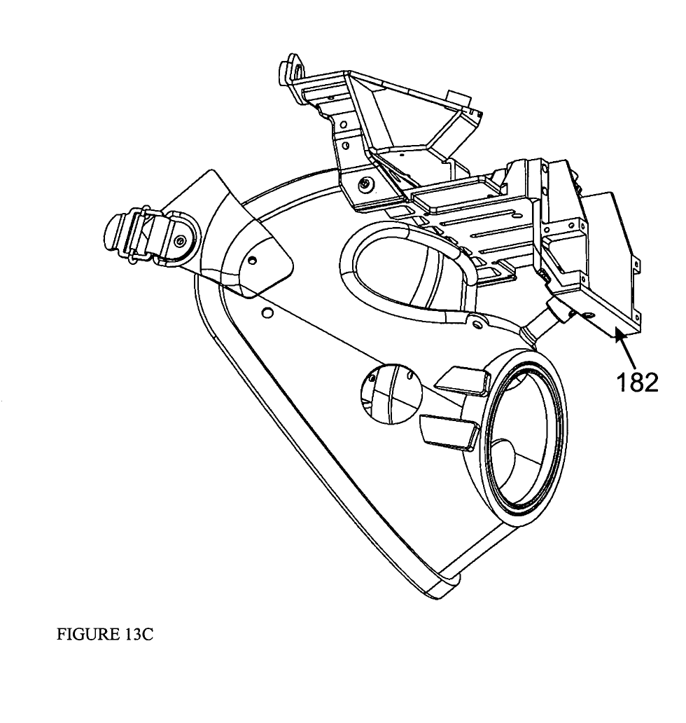

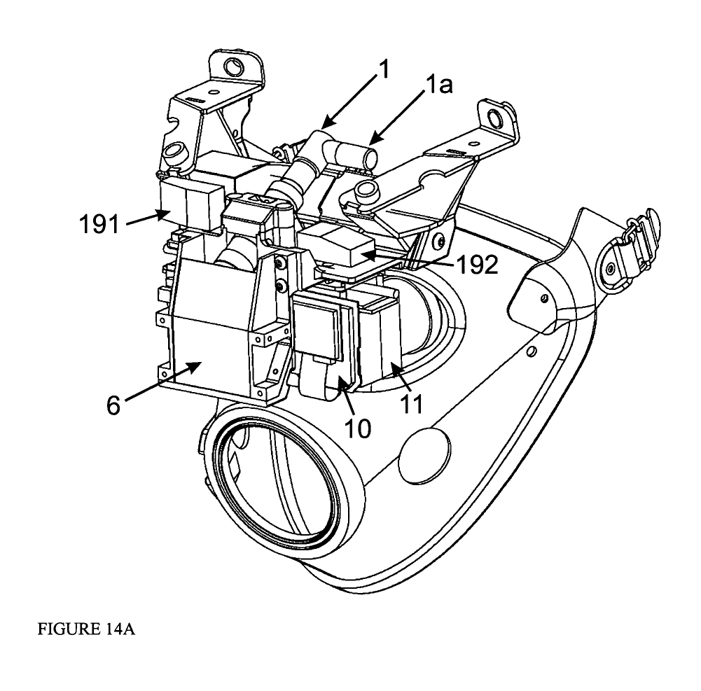

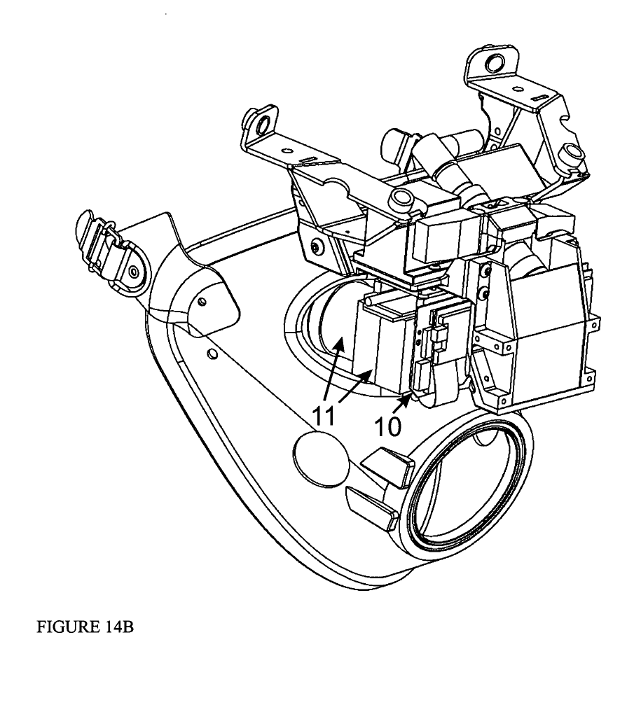

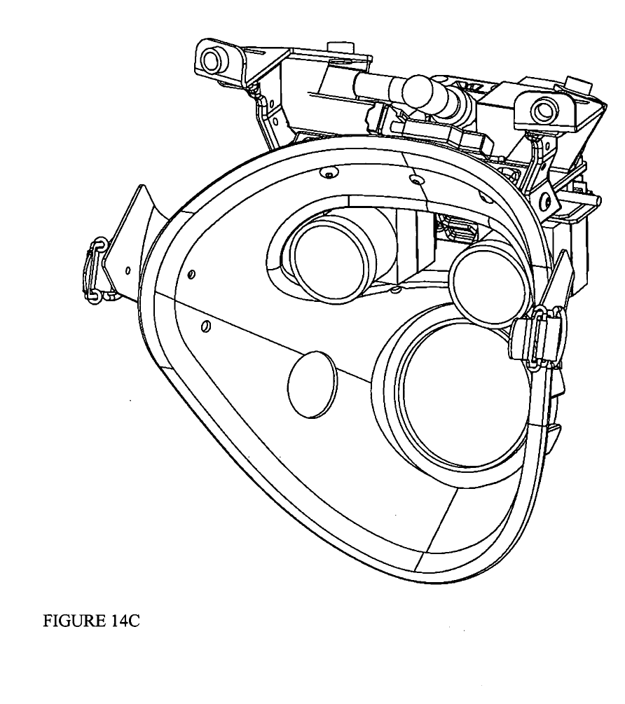

FIGS. 13A-13C show custom frame 180 mounted to SCBA 31 by lower standoff mount 184 and three bolts (not shown) that pass through openings 154. Frame 180 has coupled to it the InterSense equipment comprising front pair of microphones 34 and rear pair of microphones 35 carried on frame 170. Other components of the InterSense device are not shown for clarity purposes. Frame 180 also defines seat 182 that receives the prism, as shown below.

FIGS. 14A-14C show the active components mounted on frame 180. Prism 6 is mounted in seat 182. Camera 1 with cable carrier 1a is mounted proximate prism 6 as described above. Optics 11 and HMD 10 are placed in front of the user's eyes.

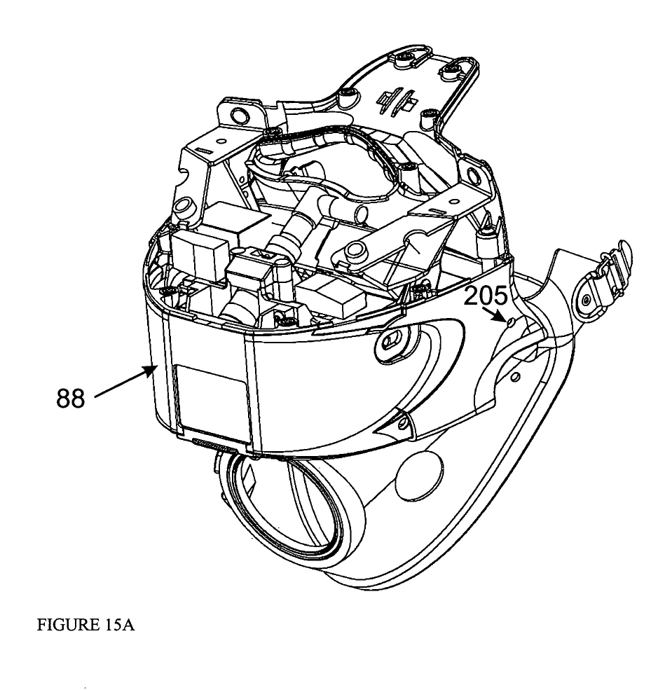

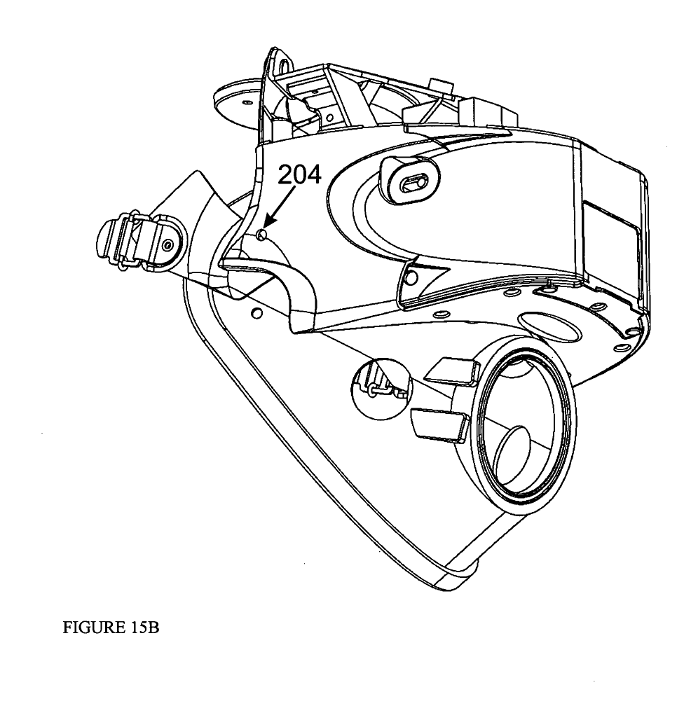

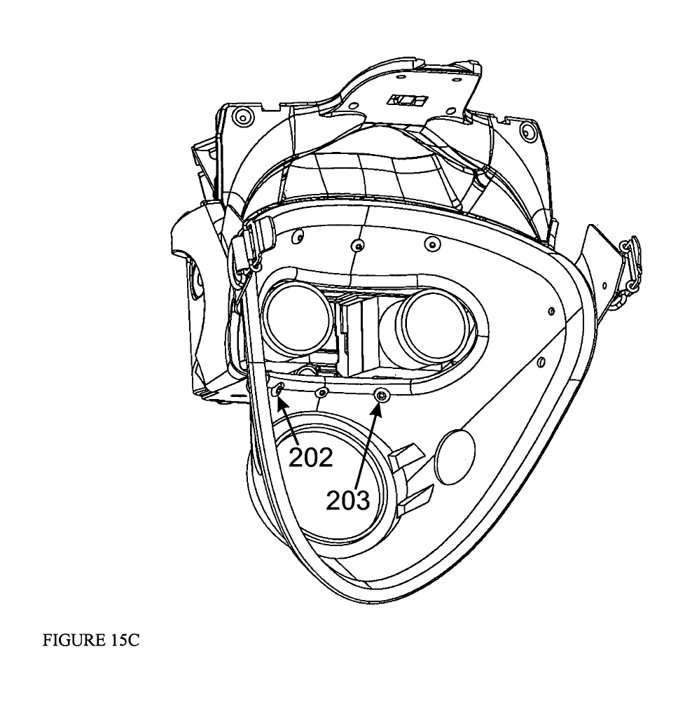

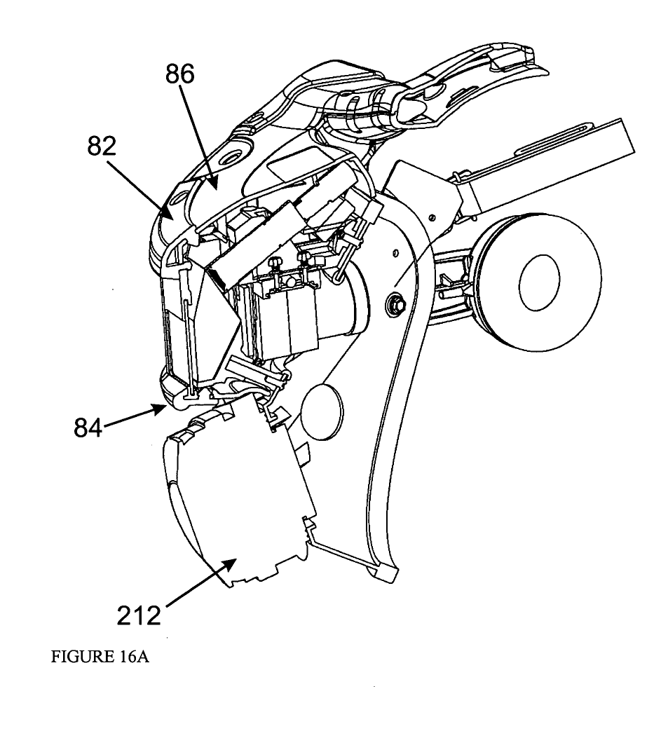

FIGS. 15A-15C show the lower shell section 88 mounted to SCBA 31 at points 202-205. Upper shell section 86, not shown in this series of figures, mounts to lower shell section 88.

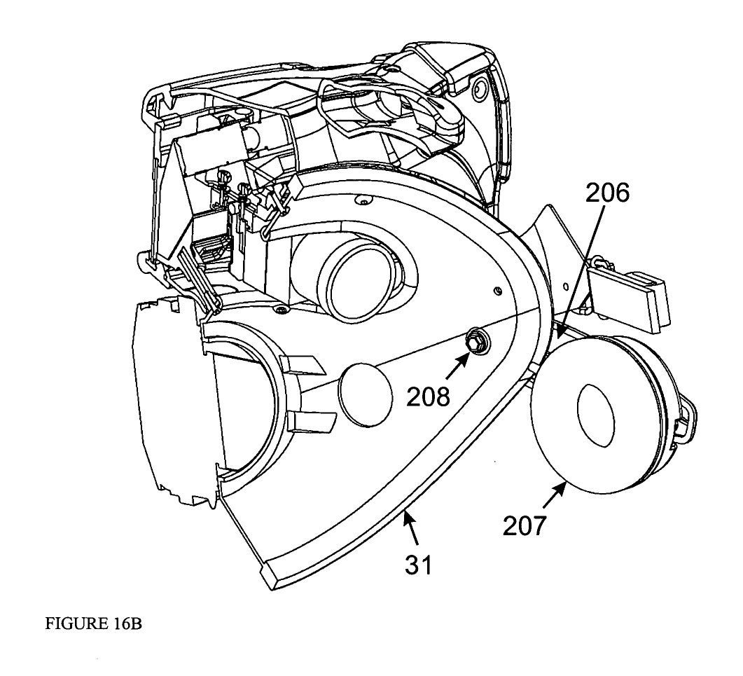

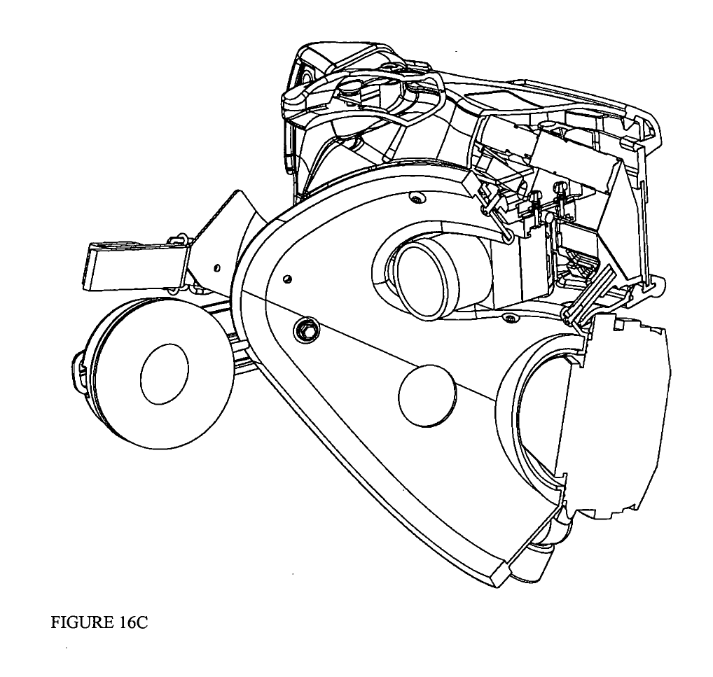

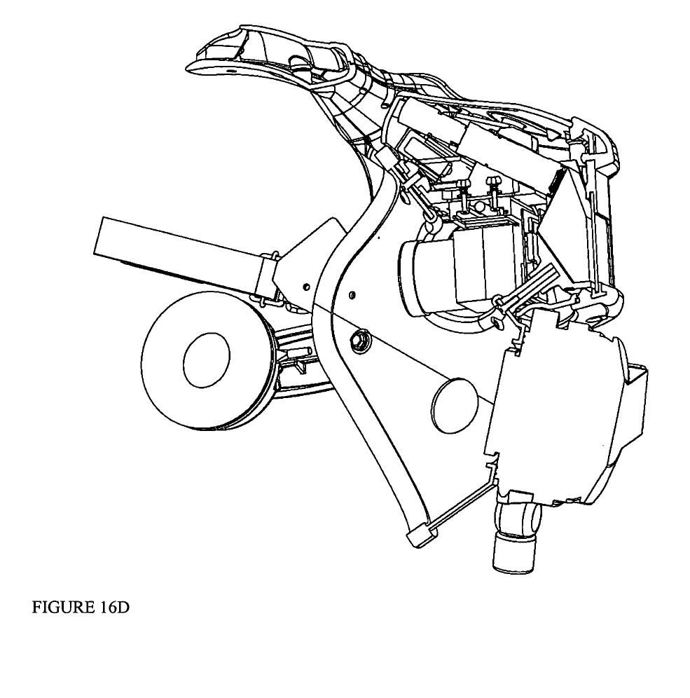

FIGS. 16A-16D are cross sections of the fully assembled device including upper shell section 86 and partial covers 82 and 84. Also shown is regulator 212 that mounts in opening 152. These drawings also show the placement of the user headphones such as right headphone 207 that is coupled to SCBA 31 by arm 206 that is bolted to SCBA 31 with bolt 208. An identical arrangement is used for the left headset portion, as shown.

1. An impact-protected ruggedized Self Contained Breathing Apparatus (SCBA) instrumented with electronic and passive equipment so that the instrumented SCBA can be used in augmented reality-based training, comprising:
a breathing portion adapted to cover at least the user's mouth and nose;
a plastic shell covering at least some of the electronic and passive equipment from shock and environmental hazards;
mechanical devices coupling the shell and the breathing portion; and
at least one resilient external member connected to the outside of the shell, to assist in the impact resistance of the shell.

2. The impact-protected ruggedized SCBA of claim 1 further comprising a tracking system for determining the location and orientation of the user's head.

3. The impact-protected ruggedized SCBA of claim 2, wherein the tracking system comprises components coupled to the shell and components located in the environment.

4. The impact-protected ruggedized SCBA of claim 3, wherein the components coupled to the shell comprise a plurality of receivers exposed to the outside of the shell, for receiving signals from the components located in the environment.

5. The impact-protected ruggedized SCBA of claim 4, wherein the receivers comprise four microphones coupled to the SCBA and organized into two pairs, with one of each pair located on one side of the user's head, and the other of each pair located on the other side of the user's head.

6. The impact-protected ruggedized SCBA of claim 5, wherein a first pair of microphones is located toward the front of the SCBA and a second pair of microphones is located toward the rear of the SCBA.

7. The impact-protected ruggedized SCBA of claim 1, wherein the instrumentation is shielded to improve tracking quality.

8. The impact-protected ruggedized SCBA of claim 1, wherein the breathing portion further comprises a compressed air breathing regulator that is used without compressed air in order to act as a one-way valve and remove exhaled air from the SCBA.

9. The impact-protected ruggedized SCBA of claim 1, wherein the breathing portion further comprises a compressed air breathing regulator that is used with compressed air, but where the SCBA is not air-tight, thus allowing the compressed air and exhaled air to exit the SCBA through gaps in the SCBA.

10. The impact-resistant ruggedized SCBA of claim 1, wherein the breathing portion further comprises a compressed air breathing regulator that is used with compressed air, but where the SCBA is air-tight, thus allowing normal use of the SCBA breathing systems, and allowing compressed air and exhaled air to exit the SCBA through the standard exit in the regulator.

11. The impact-resistant ruggedized SCBA of claim 10, further comprising an additional one-way valve to allow air into the SCBA in the case that the user inhales, and no compressed air is available.

12. The impact-resistant ruggedized SCBA of claim 1, wherein the resilient member comprises an elongated elastomeric partial cover for the plastic shell.

13. The impact-resistant ruggedized SCBA of claim 12, comprising two elongated elastomeric partial covers for different portions of the plastic shell.

14. The impact-resistant ruggedized SCBA of claim 13, wherein the plastic shell defines an upper external ridge and a lower external ridge, and one partial cover covers at least part of the upper ridge and another partial cover covers at least part of the lower external ridge.

15. The impact-resistant ruggedized SCBA of claim 14, wherein the shell defines mounting openings along the upper and lower ridges, and the partial covers comprise inwardly-projecting, enlarged-head coupling lugs that are received in such openings.

16. The impact-resistant ruggedized SCBA of claim 14, wherein the plastic shell comprises an upper and a lower section that are coupled together along a matching area and wherein at least one of the partial covers comprises inwardly-projecting coupling members that are received between the upper and lower sections of the plastic shell in the matching area.

17. The impact-resistant ruggedized SCBA of claim 14, wherein at least one of the partial covers comprises spaced inner ribs that provide more cushion to the partial cover.

18. The impact-resistant ruggedized SCBA of claim 3, wherein the components coupled to the shell comprise a plurality of optical sensors.

19. The impact-resistant ruggedized SCBA of claim 1, further comprising side louvered air vents in the SCBA located such that air flows directly over electronic equipment inside the unit.

20. The impact-resistant ruggedized SCBA of claim 1, further comprising a resilient pad attached to the plastic shell in such a manner as to support the SCBA directly onto the user's head.

21. An impact-protected ruggedized Self Contained Breathing Apparatus (SCBA) instrumented with electronic and passive equipment so that the instrumented SCBA can be used in augmented reality-based training, comprising:
a breathing portion adapted to cover at least the user's mouth and nose;
a plastic shell covering at least some of the electronic and passive equipment from shock and environmental hazards, wherein the plastic shell defines an upper external ridge and a lower external ridge;
mechanical devices coupling the shell and the breathing portion;
at least two resilient external members connected to the outside of the shell, to assist in the impact resistance of the shell, wherein the resilient members comprise elongated elastomeric partial covers, with one partial cover covering at least part of the upper ridge and another partial cover covering at least part of the lower external ridge; and
a tracking system for determining the location and orientation of the user's head, wherein the tracking system comprises components coupled to the shell and components located in the environment.

22. The impact-resistant ruggedized SCBA of claim 21, wherein the shell defines mounting openings along the upper and lower ridges, and the partial covers comprise inwardly-projecting, enlarged-head coupling lugs that are received in such openings.

23. The impact-resistant ruggedized SCBA of claim 21, wherein the plastic shell comprises an upper and a lower section that are coupled together along a matching area and wherein at least one of the partial covers comprises inwardly-projecting coupling members that are received between the upper and lower sections of the plastic shell in the matching area.

24. The impact-resistant ruggedized SCBA of claim 21, wherein at least one of the partial covers comprises spaced inner ribs that provide more cushion to the partial cover.
